(19) United States
(12) Patent Application Publication
(10) Pub. No.: US 2014/0321020 A1
(43) Pub. Date: Oct. 30, 2014

(54) FLYBACK TYPE SNUBBER CIRCUIT

(71) Applicant: INDUSTRIAL COOPERATION FOUNDATION CHONBUK NATIONAL UNIVERSITY, Jeonju-si (KR)

(72) Inventors: Yong Sug SUH, Jeonju-si (KR); Ki Hyun LEE, Gunsan-si (KR); Kyung Sub JUNG, Gunsan-si (KR)

(73) Assignee: INDUSTRIAL COOPERATION FOUNDATION CHONBUK NATIONAL UNIVERSITY, Jeonju-si (KR)

(21) Appl. No.: 14/259,487

(22) Filed: Apr. 23, 2014

(30) Foreign Application Priority Data
Apr. 29, 2013 (KR) 10-2013-0047448

(51) Int. Cl. H02H 3/20

(52) U.S. Cl. CPC H02H 3/20
USPC 361/91.5

(57) ABSTRACT

A flyback type snubber circuit includes an transformer configured to have a primary side connected between a power source and a switch and have a secondary side connected to a diode. The diode is connected between the power source and the transformer.

### CROSS REFERENCE TO RELATED APPLICATION

The present application claims the benefit of Korean Patent Application No. 10-2013-0047448 filed in the Korean Intellectual Property Office on Apr. 29, 2013, the entire contents of which are incorporated herein by reference.

### BACKGROUND OF THE INVENTION

1. Technical Field

The present invention relates to a flyback type snubber circuit, and more particularly, to a flyback type snubber circuit configured to function as an auxiliary circuit for protecting a semiconductor device used in a medium voltage power conditioning system.

2. Description of the Related Art

A switching device used in a medium voltage power conditioning system is turned on or off in response to a switching device driving signal from a gate driver. In general, the switching device has been implemented using a Gate Turn-Off (GTO) thyristor or an Insulated Gate Bipolar Transistor (IGBT).

The IGBT, that is, a conventional switching device, is fast in speed, but is problematic in that it has a small capacity. In contrast, the GTO thyristor has a high capacity, but it is disadvantageous in that speed is slow. The trend of a medium voltage power conditioning system should be increased in capacity and precisely driven at high speed, but the conventional IGBT and GTO thyristor are no longer suitable for such a trend.

In line with the trend, an Integrated Gate Commutated Thyristor (IGCT) comes to the fore because it has a high-speed switching operation and it is suitable for a high capacity. If the IGCT is used, however, there is a problem in that a switching device is damaged by overvoltage or overcurrent that is instantly generated. An additional protection circuit is added to the IGCT in order to make the operation of the IGCT smooth.

FIG. 1 is a circuit diagram showing conventional snubber circuit used to protect an IGCT. The conventional snubber circuit prevents suddenly increasing current into a switching device SW through an inductor connected between an input power source C_{DC} and a switch. A diode D_{Cl} and a capacitor C_{Cl} are connected to form a current path, and thus stored energy in the inductor is transferred to the capacitor C_{Cl} and stored therein when the switch is turned-off. A resistor R_{Cl} is connected between the capacitor C_{Cl} and the input power source C_{DC} in order to maintain energy stored in the capacitor C_{Cl} and DC-link capacitor in an equilibrium state and to maintain the DC-link voltage until the switch is turned on again.

The conventional protection circuit requires the capacitor C_{Cl} for forming a current path and storing energy in a switch-off state and the resistor R_{Cl} for connecting the capacitor C_{Cl} and the DC-link capacitor. The resistor R_{S} causes an energy loss, thereby deteriorating efficiency of a medium voltage power conditioning system. Furthermore, there is a problem in that the total size of the system is increased due to the resistor R_{S} and the capacitor C_{CL}.

### PRIOR ART DOCUMENT

### Patent Document

(Patent Document 0001) Korean Patent Application Publication No. 2009-0085921 (Aug. 10, 2009)

### SUMMARY OF THE INVENTION

Accordingly, the present invention has been made keeping in mind the above problems occurring in the prior art, and an object of the present invention is to provide a flyback type snubber circuit capable of minimizing a loss attributable to switching.

Another object of the present invention is to minimize stress applied to a device when a switch is turned on or off.

Yet another object of the present invention is to maximize efficiency of a medium voltage power conditioning system using an IGCT.

In an aspect of the present invention, there is provided a flyback type snubber circuit, including a transformer configured to have a primary side connected between the input power source and a switch and have a secondary side connected to a diode and the diode connected between the input power source and a transformer.

In an embodiment of the present invention, the transformer may be the isolated transformer, and the isolated transformer may be a FlyBack Transformer (FBT) comprising a magnetizing inductance component.

In another embodiment of the present invention, in the transformer, the primary side connected to the input power source and the switch and the secondary side connected to the diode may have a transformation ratio of M:N (N is greater than M).

In an embodiment of the present invention, the transformation ratio of the transformer is controllable.

### BRIEF DESCRIPTION OF THE DRAWINGS

FIG. 1 is a circuit diagram showing an IGCT protection circuit including a conventional snubber circuit; and

FIG. 2 is a circuit diagram showing an IGCT protection circuit including a flyback type snubber circuit of the present invention.

<Description of reference numerals of principal
elements in the drawings>

| | |
|---|---|
| 10: transformer | 20: power semiconductor |
| 30: free-wheeling diode | 40: load inductor |
| 50: diode | 60: input power source |

### DETAILED DESCRIPTION

An exemplary embodiment of the present invention is described in detail with reference to the accompanying drawings.

FIG. 2 is a circuit diagram showing an IGCT protection circuit including a flyback type snubber circuit of the present invention.

The flyback type snubber circuit of the present invention includes transformer 10 and a diode 50. The transformer 10 has a primary side connected between an input power source 60 and a switch and a secondary side connected to the diode 50. The diode 50 is connected between the input power source 60 and transformer 10.

If a power semiconductor 20 used as the switch is in the on state, an electric current flows from the input power source 60 to a power semiconductor 20, a free-wheeling diode 30, and a load inductor 40 via the primary side of the transformer 10. If the switch shifts from the on state to the off state, an electric current from the input power source 60 no longer flows into the rear of the power semiconductor 20.

Stored energy in the transformer 10 moves along the path along which the energy returns to the input power source 60 through the diode 50. Energy from the input power source 60 is added to the energy until the switch is turned on again so that energy in the DC link of the input power source 60 may be recovered.

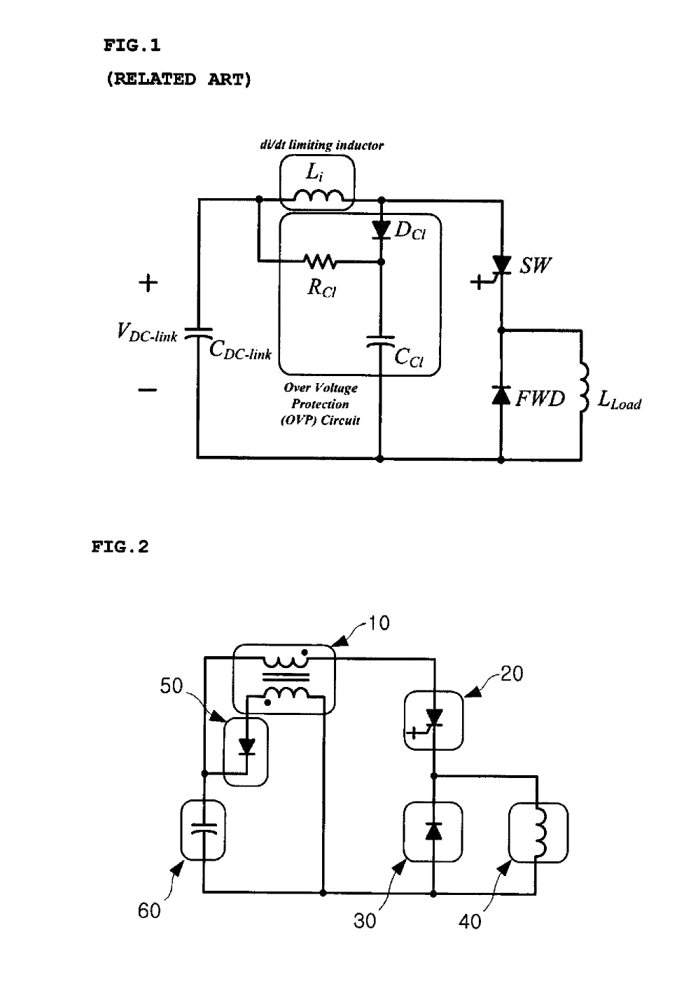

The transformer 10 of the present invention prevents an instant and sudden change of current attributable to switching. The transformer 10 is compared with FIG. 1 including the conventional snubber circuit. In FIG. 1, the inductor connected between the input power source 60 and the switch has the same function, and overvoltage is prevented by limiting the di/dt characteristic of the switching device. The diode 50 and transformer 10 of FIG. 2 perform the functions (i.e., storing energy and maintaining voltage) performed by the capacitor C_{Cl} and the resistor R_{Cl} in the conventional snubber circuit of FIG. 1.

The transformer 10 of the present invention may reduce the size of a flyback type snubber circuit because the additional capacitor C_{Cl} and resistor R_{Cl} are not used and may improve energy efficiency by preventing an energy loss occurring due to resistance.

In an embodiment of the present invention, Transformer 10 may be an isolated transformer. Furthermore, the isolated transformer may be a FlyBack Transformer (FBT) including a magnetizing inductance component.

In the conventional method shown in FIG. 1, an additional inductor must be added. In accordance with the present embodiment, however, an inductance component within the FBT may replace the function of the conventional inductor. Accordingly, the number of elements used to form a flyback type snubber circuit can be reduced, and the size of the entire circuit can be reduced. If an additional inductor element is included in a circuit as in the prior art, all the characteristics of the circuit may be affected. In contrast, the present invention may prevent a problem in that circuit characteristics are changed due to a change of inductance because the FBT is used and an additional inductor element is not used.

In another embodiment of the present invention, in the transformer 10, the primary side connected to the power source 60 and the switch and the secondary side connected to the diode 50 have a transformation ratio of M:N (N is greater than M). In accordance with the present embodiment, overvoltage occurring in the switch may be minimized because the amount of voltage transferred by the input power source 60 is reduced.

In another embodiment of the present invention, the transformation ratio of the transformer 10 may be controlled. In the conventional snubber circuit (refer to FIG. 1), the capacity of the capacitor C_{Cl} is determined in the circuit design stage and is not changed after the circuit is completed. In accordance with the present embodiment, however, the transformer 10 is formed of a variable isolated transformer 10 having a controllable transformation ratio. In the switch-off state, the input power source 60 may control the amount of voltage that is transferred to a part to which the transformer 10 and the diode 50 are connected. Accordingly, voltage stress applied to the switch may be minimized flexibly according to circumstances.

In accordance with the present invention, stress applied to the device can be minimized when a switch is off, and a loss attributable to switching can be minimized.

According to the present invention, efficiency of a medium voltage power conditioning system using an IGCT can be maximized.

The present invention is advantageous in that the size of the entire circuit can be reduced because a resistor and a capacitor used in a conventional snubber circuit are omitted.

The present invention is advantageous in that an energy loss attributable to resistance can be prevented because a resistor is not used.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A flyback type snubber circuit, comprising:
an transformer configured to have a primary side connected between a power source and a switch and have a secondary side connected to a diode; and
the diode connected between the power source and the transformer.

2. The flyback type snubber circuit of claim 1, wherein the transformer is an isolated transformer.

3. The flyback type snubber circuit of claim 2, wherein the isolated transformer is a FlyBack Transformer (FBT) comprising a magnetizing inductance component.

4. The flyback type snubber circuit of claim 1, wherein in the transformer, the primary side connected to the power source and the switch and the secondary side connected to the diode have a transformation ratio of M:N (N is greater than M).

5. The flyback type snubber circuit of claim 1, wherein the transformation ratio of the transformer is controllable.
